(19) United States
(12) Patent Application Publication
(10) Pub. No.: US 2015/0169189 A1
(43) Pub. Date: Jun. 18, 2015

(54) MEDIA RECOMMENDATION KIOSK

(71) Applicant: Google Inc., Mountain View, CA (US)

(72) Inventors: Roy Want, Los Altos, CA (US); William Noah Schilit, Mountain View, CA (US)

(21) Appl. No.: 13/765,880

(22) Filed: Feb. 13, 2013

(51) Int. Cl. G06F 3/0484

(52) U.S. Cl. CPC G06F 3/04842

(57) ABSTRACT

A publicly accessible kiosk is provided whereby individuals who connected to the kiosk may share or exchange information about electronic applications, books, magazines, movies, music or the like with other individuals connected to the same kiosk. Two or more mobile devices may be detected. Each mobile device may be connected to a publicly accessible interface. A preference may be received for each device connected to the publicly accessible display. A personalized display may be provided on the publicly accessible interface based on the preference.

### BACKGROUND

Social interaction regarding a movie, a book, a magazine, or the like can occur between individuals when they are co-located. For example, at a book store, two individuals who are browsing the same topic area or even the same book may strike up a conversation about other books or movies that each has read or seen. This social interaction may facilitate a personal recommendation for content (e.g., a book, a movie). As electronic devices have propagated and permeated content-providing roles that once were reserved for physical stores or shops, users no longer need to visit a book store or movie store to make a purchase or rental. Instead, these tasks may be accomplished from the device itself. In place of the past social interaction, some websites recommend other products to a user based on the purchases made by people who bought the same item or the user's purchase history. But such websites do not enable two individuals who are co-located to discuss the items that they actually own or to provide a personal recommendation from one owner to a potential purchaser.

### BRIEF SUMMARY

According to an implementation of the disclosed subject matter, a first mobile device such as a phone may be detected. A first preference, corresponding to a first user, may be received. An example of the first preference may include without limitation a gender, an age, a collection of applications on the mobile device, a subset of applications, a most-viewed application set, a most-used application set, a most recently used application set, a collection of movies, a collection of music, a collection of books, and a collection of magazines. Content to display to the first user on a digital sign based on the first user's preference may be determined. Content may refer to, for example, an application, a movie, a song, a book, a magazine, etc. The content may be displayed to the user on a digital sign. A second mobile device belonging to a second user may also be detected and a second preference may be received. Content may be presented to the second user on the digital sign based on the first preference, the second preference, or both the first and second preference.

Two or more mobile devices may be detected. Each mobile device may be connected to a publicly accessible interface such as a podium, a digital sign, or a podium and a digital sign. The publicly accessible interface may include a display that is accessible simultaneously by the two or more users or it may be a non-interactive screen. A preference may be received that corresponds to each mobile device and/or each user. A personalized display on the publicly accessible interface may be provided based on the preference received. Alternatively or in addition, personalized displays may be provided on a digital sign or other publicly-accessible interface based on the preferences.

According to an implementation, a system is provided that includes a database and a processor. The database may store at least one preference of at least one user. The processor may be connected to the database and configured to detect a first mobile device. The processor may determine content to display to the first user on a digital sign, such as based on a preference corresponding to the user. Further, the processor may detect a second mobile device, and determine content to display to the second user on the digital sign based on a second preference associated with that user. The processor may be configured to provide a recommendation of at least one application to one or both users, such as by displaying suggested applications on the digital sign. In some configurations, the processor may detect a second mobile device and receive a second preference corresponding to a second user. It may determine content to display to the second user on the digital sign based on the first preference and the second preference and display the content to the second user on the digital sign.

In an implementation, a system is provided that includes a database and a processor. The database may store at least one preference from at least one user. The processor may be connected to the database and configured to detect a plurality of mobile devices, where each of the plurality of mobile devices is connected to a publicly accessible interface. It may receive a plurality of preferences, where one of the plurality of preferences is associated with one of the plurality of users. The processor may provide a personalized display on the publicly accessible interface based on the preference.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 shows an example process for displaying content on a digital sign according to a preference received from a user.

FIG. 4 shows an example of a digital sign or interface that is being used by a single user.

FIG. 5 shows an example of a digital sign or interface that is being used by two users.

FIG. 6 shows an example of a digital sign or interface that is being used by a group of users.

FIG. 7 shows an example process flow for displaying content on a publicly accessible interface according to preferences received.

### DETAILED DESCRIPTION

This disclosure proposes to change the way individuals make content selections with their mobile devices by allowing multiple users to access a kiosk or a publicly provided monitor simultaneously. Each user may view content associated with their account and/or mobile device that overlaps with the content other users may have on their electronic devices (or associated with their respective accounts) that may interest one or more of the users. For example, a digital kiosk may be provided that is publicly accessible by one or more individuals. Each user connected to the kiosk may exchange information about, for example, the applications, movies, music, books, or other content the user has on a device, with other users who are connected to the same kiosk. When multiple users are connected to the kiosk, the users may be able to view a list or graphical display of content that each user has on their devices or associated with their accounts respectively. The list or graphical display may also show content (e.g., movies of a particular genre) for which the users have overlapping interests. For example, each user may be presented with an overlap of the content between the two users that shows documentary movies each user owns, and documentary movies that the user does not have but that the other user has viewed, downloaded, or purchased. Each user also may be shown other applications that may be of interest to the user, based on, for example, applications other users have and/or other preference information such as popularity. A user may discuss, for example, applications that are recommended and thereby receive a personal recommendation.

The ability to view on the kiosk the overlapping content between users connected to the kiosk may facilitate group conversations at the kiosk and enhance the ability of people to exchange recommendations from their libraries of content in a more traditional form (e.g., person to person). For example, a digital sign may display a graphical view of books owned by a first person and books owned by a second person. An overlap, showing books that the first and second person have in common, may be displayed. The overlap may even be narrowed by, for example, genre of book (e.g., history, fiction, comedy, etc.) Based on that overlap, a recommendation of a book owned by the second person, but not the first person, may be highlighted for the first person. Likewise, a book owned by the first user, but not the second, may be highlighted for the second person. The first person may, based on the information displayed on the digital sign, notice that the second person has read a particular electronic book that the first person has been reluctant to purchase. The first person may solicit the second person's opinions on the book. The first person may make a selection of the book which may in turn, be purchased, downloaded to the first person's electronic device and/or associated with the first person's user account. The book may be added to a purchase queue. The user may also elect to flag the book for purchase, for example, and receive an email or text about the book at a future date as a reminder.

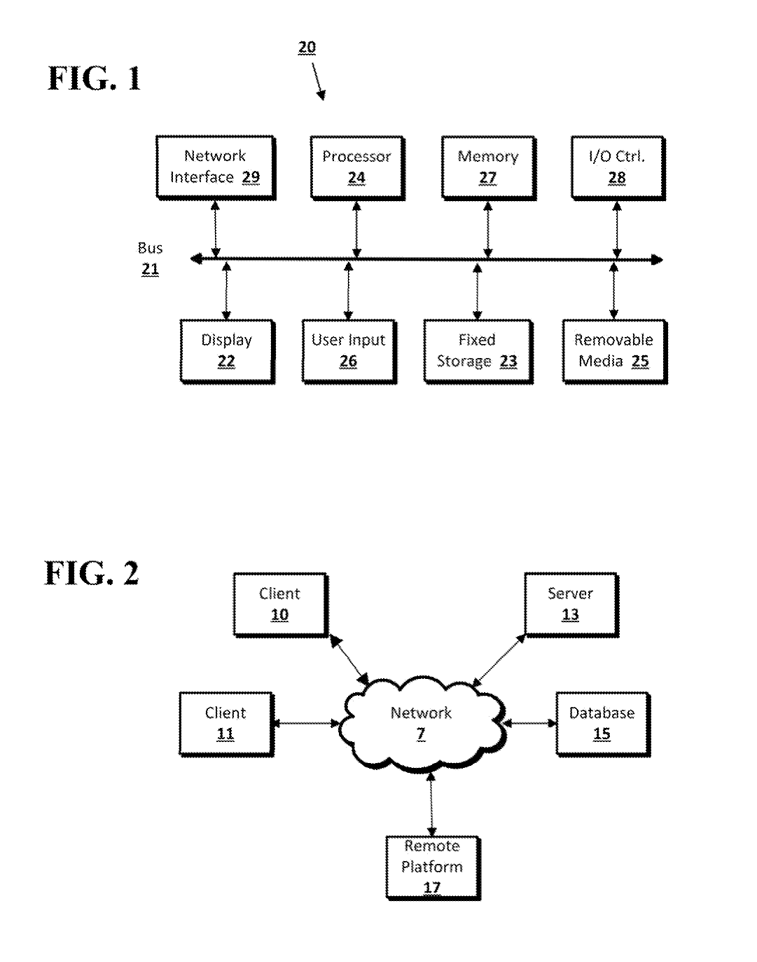

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

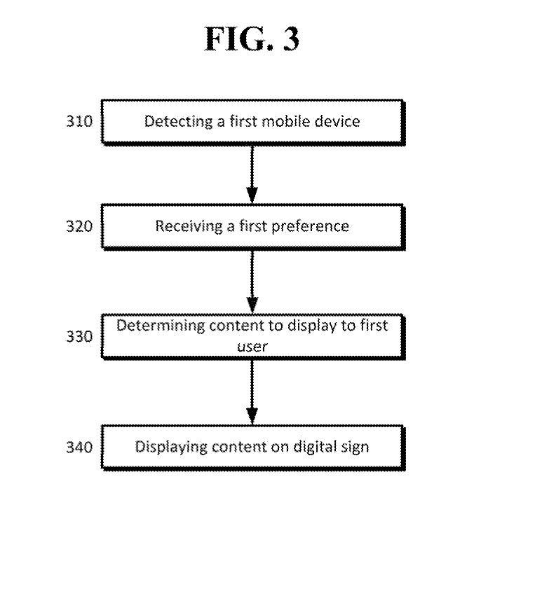

In an implementation shown in FIG. 3, a first mobile device may be detected at 310, such as by a kiosk or similar device as disclosed herein. A mobile device may be, for example, a smartphone, a tablet, or other similar mobile electronic computing device. A first preference corresponding to a first user may be received at 320. A preference may include, for example, a gender, an age, a collection of applications on the mobile device, a subset of applications, a most-viewed application set, a most-used application set, a most recently used application set, a collection of movies, a collection of music, a most-listened-to collection of music, a most-viewed collection of movies, a collection of books, and a collection of magazines. As a specific example, a preference may indicate whether a user prefers a book, movie, song, or the like, or a specific rating that the user has assigned to such content. A preference may, for example, be determined based on a user's web browsing history, purchase history, download history, or a user-indicated interest. The preference may be transmitted from the mobile device and correspond to the user in possession of the device, such as where the preference indicates a relative rating that the user has assigned to a content item on the device. Generally, a single preference may be received from each mobile device. However, in some configurations, two or more electronic devices may be associated with a single user account, and a preference may refer to the information associated with the user's account rather than a preference generated for each device belonging to the user. Multiple preferences may be received simultaneously or sequentially from multiple mobile devices. A preference also may refer to information collected from a mobile device. For example, information about applications, music, multimedia, or any similar content or frequency of use data regarding the same may be generated or provided on a per device basis, stored on a server, stored on the mobile device, or any combination thereof.

Content to display on a digital sign may be determined based on the first preference at 330, and the content may be displayed on the digital sign at 340. Content may refer to, for example, a digital video (e.g., multimedia), a digital copy of a book, an application, a digital copy of a magazine, or a digital copy of music. The preference, for example, may indicate that a user enjoys classical music. Based on this preference, the digital sign may present popular or recent classical music selections. For example, a user may request the sign to display music. The sign may obtain a list of classical music currently residing on a user's mobile device or otherwise associated with a user account. Based on the user's collection of music and/or the user's preference, a list of classical music that may interest the user may be displayed.

In some configurations, supplemental content may be presented on the digital sign. Supplemental content may refer to content not directly obtained from the user preference. For example, it may include a recommendation for other applications, music, movies, magazines, or the like and that recommendation may be based on content that is trending, popular, or most-viewed, or most-downloaded. It may include graphical information such as a logo or art. It may refer to promotional or advertising content as well. Content or supplemental content may have a non-visual component. For example, speakers embedded into the digital sign or associated therewith may provide audio content or feedback such as a song or an alert sound.

The digital sign may be connected to an assortment of hardware (e.g., a computing device) or have the hardware included as a component of the digital sign itself. For example, the digital sign may have a network interface card, a wireless card, or any other hardware sufficient to provide access to a network or the Internet. The digital sign may be connected to a computing device that provides such functionality as well. The digital sign and/or the computing device may include a processor, memory, and storage. As mentioned earlier, the digital sign may contain or be connected to with one or more monitors and/or one or more speakers. References to the digital sign above and below include the sign and associated hardware components.

The digital sign may be publicly accessible and accessible by multiple users simultaneously. For example, the digital sign may be a kiosk at a shopping mall that is readily usable by any passerby. If the sign is composed of a single monitor and a single user interacts with it, the monitor may display content to the user using a portion of the monitor or the entire monitor. If more people connect to the digital sign, the monitor space may be apportioned based on the number of individuals in proximity to it or from whom a preference has been received (e.g., based on the number of electronic devices connected).

The digital sign may have multiple monitors. In some configurations each monitor may be assigned to or used by a single user while in other configurations it may be desirable to allow a monitor to be apportioned to multiple users. The monitors or screens may be non-interactive, that is, the monitor or monitors may not respond to a touch, a gesture, or neither a touch nor a gesture. Instead, interaction may be provide by, for example, a local control device (e.g., connected to a podium in proximity to the digital sign) or by an application that is used to interface with the digital sign, such as an application executing on a mobile device of a user interacting with the sign.

In an implementation, a second mobile device may be detected and a second preference may be received. The second preference may correspond to a second user, a second mobile device, or an account associated with the user, as previously described. Content to display to the second user on the digital sign may be determined based on the first preference, the second preference, or a combination of the first preference and the second preference. The content may be displayed to the second user on the digital sign. Similarly, the content displayed to the first user may be based on the first preference, the second preference, or a combination of the first preference and the second preference. Thus, the digital sign may display content to multiple users based on each individual's preference or combination thereof.

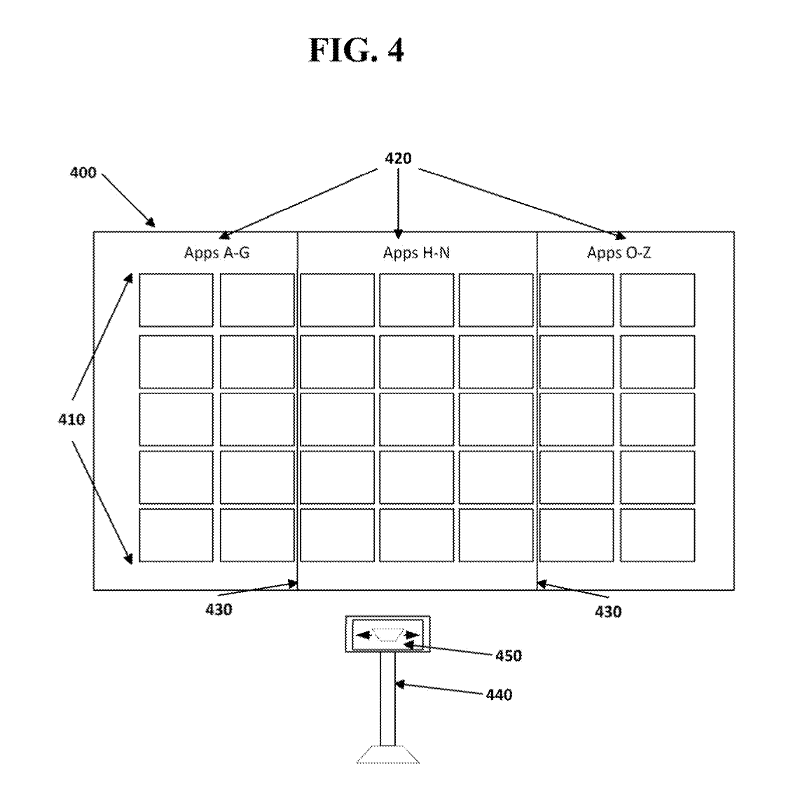

Examples of the digital sign are provided in FIGS. 4-6. FIG. 4 is an example of the digital sign 400 when accessed by a single user, such as via a mobile device. A user may elect to interact with the digital sign 400 by activating an application on the mobile device. The application may search for a digital sign 400 in proximity to the respective mobile device. For example, a phone may identify a digital sign 400 associated with a GPS coordinate and/or interface with the identified sign 400 using a Bluetooth protocol or other wireless protocol. As another example, the application may operate in the background of a mobile device and the digital sign may actively scan for devices in proximity to it. If it detects a nearby device, the digital sign may send a notice to the user that, for example, requests the user's permission to interact with the sign (e.g., provide a preference). As another example, a user may physically tether a device to the digital sign 400 using a cable such as a USB cable that may be provided by the podium 440. The podium 440 may be used to login in lieu of or in addition to connecting a mobile device. For example, a user may input a username and password for a user account using the podium controls 450. The system may connect to a server that over a network that provides information about the user's preferences regardless of how the user discovers a proximal digital sign 400.

Upon connecting to the sign 400, the user may elect to send or allow the digital sign 400 to retrieve specified information about, for example, the music, electronic books, or other content currently associated with the user's account or that resides on the connected mobile device. In FIG. 4, the user has elected to have the digital sign 400 display a list of applications 410. The applications 410 are displayed in various categories 420, in this case, alphabetically. Dividers 430 separate the categories on the display. The applications 410 may be navigated using the podium controls 450 or controls provided by an application used to interface with the digital sign 400, for example. The applications 410 displayed may represent recommendations based on the user's preference as previously described. For example, they may be other applications available for download, purchase, or otherwise available for the user to install on his device, which the sign determines may be of interest to the user as previously described.

In an implementation, a recommendation of at least one application may be provided to the first user, a second user, or the first user and the second user. The recommendation may be displayed to the first user, the second user, or the first user and second user on the digital sign. A recommendation may refer to, for example, an advertisement or a promotion or the like. A recommendation may be generated based on a user's preference such as activity history. For example, if a user continuously browses classical music selections at an online music store, then the user may be determined to have an interest in classical music as compared to other genres of music. In the event the user is searching for music to download using the digital sign, the user's preference for classical music may be used to bias the results returned to favor classical music. An activity history may be, for example, browser activity, purchase history, or the like. The information utilized to generate the recommendation may be associated with an account of the user or with the specific mobile device that is connected to the digital sign. A recommendation may be shown to the user by overlapping the content present on the first user's mobile device with the similar content on the second user's mobile device and this overlap may be presented to at least one of the first user or the second user. For example, the overlap between the content may be segmented based on one or more of data type, genre, frequency of use, title, rating, or content type.

An overlap of content may refer to content that two or more users have on their mobile devices or that is otherwise associated with their respective user accounts. In some instances, three or more individuals may be interacting with a sign. Any content present on two or more of the individuals' devices may be displayed as an overlap. An indication, such as a highlight or an empty space, may be shown for any user that does not have content that is present in the other two devices (i.e., that overlaps for two or more users). In the event that only two users are interacting with a digital sign content that is present on both users' devices or otherwise associated with both users' accounts. A recommendation may be made where one user is lacking content that the other user has. For example, if both users enjoy classical music, they may share many songs in common. However, there may be one or more songs that one user has that the other does not. The overlapping display of content may reflect such gaps in the one user's collection.

In an implementation, a recommendation may be made for a service. For example, a user may interface with a digital sign at a shopping center. The user may navigate to information about dining establishments in close proximity to the user's location. The sign may suggest restaurants to the user, based on the user's preference, the preferences of one or more other users connected to the same sign, or any combination thereof. Other examples of services that may be recommended include, but are not limited to, a hotel, a store, or a movie showing. A recommendation may also be based on region-specific data independent of or including information obtained from users who connect to the digital sign. For example, a restaurant may receive many recommendations in one location but the same chain restaurant at a separate location may be less well received and, therefore, not recommended.

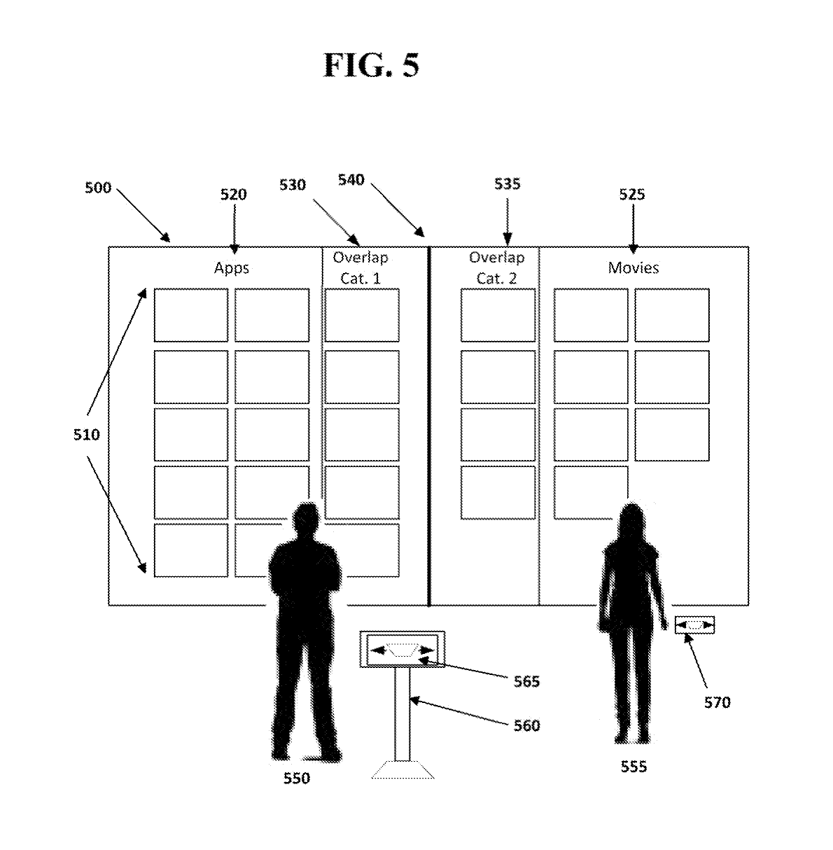

FIG. 5 shows an example of the digital sign 500 where two users 550, 555 are simultaneously interacting with it. The first user 550 may use the podium 560 and the podium controls 565 to log in to the digital sign 500. The digital sign 500 in this example is a single monitor that has been divided in half. The divider 540 between the two users' 550, 555 portions of the screen may be created by a black bar, for example. The left half of the digital sign 500 may be assigned to the first user 550. The first user may elect to browse the applications category 520. The sign 500 may show a list of applications 510 that the user has in the category of applications 520. The right-most column of applications 510 may represent those applications 510 that the first user 550 has in common with the second user 555 and the applications 510 listed under “Apps” 520 may represent those applications 510 that are recommended to the user based on the first user's preference, the second user's preference, or a combination thereof. The first user 550 may navigate or scroll through the applications 510 under either the Apps 520 columns or the Overlap Category 1 column 530. In some configurations, more than one overlap category may be displayed on the digital sign 500. For example, the first user 550 may also simultaneously have an Overlap Category 1B column for music that is in common with the second user 555. Likewise, the digital sign may have a few columns for “Music,” similar and/or in addition to that of Apps 520, that may represent music recommended to the first user 550 based on the first preference, the second preference, or a combination thereof.

FIG. 5 shows that the second user's 555 display on the digital sign 500 may show different content than that shown to the first user 550. The second user is browsing “Movies” 525 in this example. The Overlap Category 2 535 may have one or more columns that shows, for example, comedy movies that both users have in common. The columns under the Movies 525 heading may represent suggestions of content based on the overlapping content between the two users and/or their individual preferences. While the first user 550 may navigate the sign 500 and make selections of content using the podium controls 565, the second user may be interacting with the digital sign using a mobile device 570 that is running an application. The application may provide the second user 555 with the ability to navigate the sign 500 and make corresponding content selections. Selection of content may cause the content to be downloaded, purchased, associated with an user account, flagged for later review by the user (e.g., the user may receive an email or text message at a future date), or any combination thereof.

As an example, the second user and the first user may both have an affinity for movies of the comedy genre. The first user may have purchased, downloaded, viewed the following movies or the movies may otherwise be present on the user's mobile device or associated with the user's account: A, B, C, D, and E. Similarly, the second user while the second user may have comedy movies B, D, E, and F. The digital sign may display to the first user the movies A through E and indicate that B, D, and E are movies that the first user has in common with the second user. The digital sign also may indicate that within the comedy category of movies, the second user has movie F for which the second user has assigned a five star rating. The first user may view information about movie F on the digital sign or flag movie F to view information about it later. The second user may see on the digital sign that the first user also has movies B, D, and E. The digital sign may highlight or otherwise indicate that movies A and C are movies that the first user has viewed. The second user may make inquiries about those movies to the first user, and/or obtain information about movies A and C from the digital sign, such as by interfacing with the sign via the user's mobile device.

The first or the second user may make a selection of the content, supplemental content, recommendation, or any combination thereof. Continuing the above example, the first user may select movie F for download or purchase or the first user may flag movie F to review later, gather more information, or add to a wish list. The supplemental content may be associated with the first user's account, for example, to allow the user to access the content independently of the mobile device from which the purchase was made (e.g., the user may access the content from a laptop or desktop computer). Content selections may be made using a variety of interface mechanisms with the digital sign. For example, the digital sign may be interfaced with using an application. The application may receive user selection of content by way of the application. As another example, the digital sign may be accompanied with a podium that allows a mobile device to interface with the digital sign. The podium may contain navigation controls for the user to interact with what is displayed on the monitor. In some configurations, more than one podium may be present. In some configurations the podium may have multiple independent controls to accommodate multiple users simultaneously. Selection or flagging of content by the user may cause the content to be associated with an account of the user. For example, the user's mobile device, the digital sign, the podium, or any combination thereof may be connected to the Internet. A user's account may be stored in a cloud service, for example. If a user elects to interface with the digital sign, the user may also elect to allow the digital sign to connect with an account associated with the user or the user's mobile device.

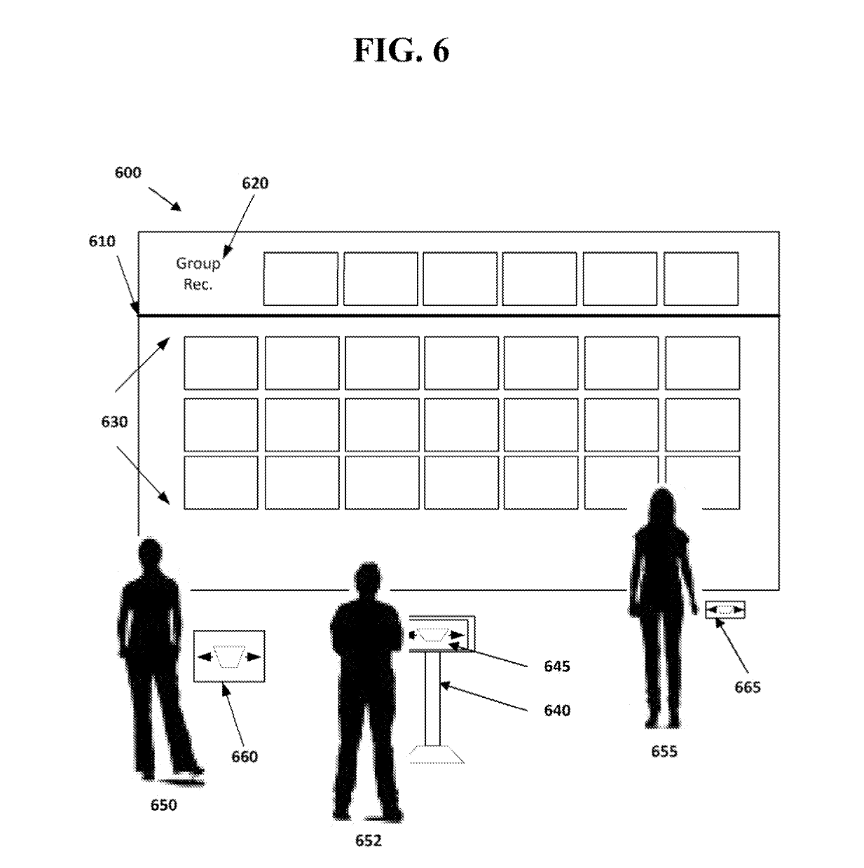

FIG. 6 shows an example implementation in which a group of individuals are simultaneously interacting with a publicly accessible interface 600. Each user is utilizing a different mechanism to access and/or interact with the interface 600. The first user 650, the second user 652, and the third user 655 are using a tablet 660, a podium 640 (including podium controls 645), and a smartphone 665, respectively. In contrast to FIG. 5, which shows a digital sign divided into two spaces for each user, FIG. 6 shows that the interface 600 may utilize the entire space available and display content based on the collected preferences from each of the users. The applications 630 that may be of shared interest based on the user preferences as previously described, may be shown, as well as an indication of which applications are associated with each user. The interface 600 may display recommendations to the users based on, for example, application ratings, user preferences, popularity, location, frequency of the application among the group of people connected to the interface 600, or any combination thereof, as previously described. In this example, recommendations 620 are arrayed horizontally and separated from the more general list of applications 630 by a divider 610. Navigation and selection of the content may be performed simultaneously by each user or a user may be designated as having priority (e.g., based on order of connection to the interface 600). In some configurations, the content displayed on the interface 600 may be rotated at predefined intervals and using predefined content and categories. For example, the interface may rotate between showing applications, music, multimedia, and books. Users connected to the interface may have a cursor that is numbered or that appears in a unique color for each user. The user may position the cursor over content for which the user would like to obtain more information, flag the content, download the content, or purchase the content.

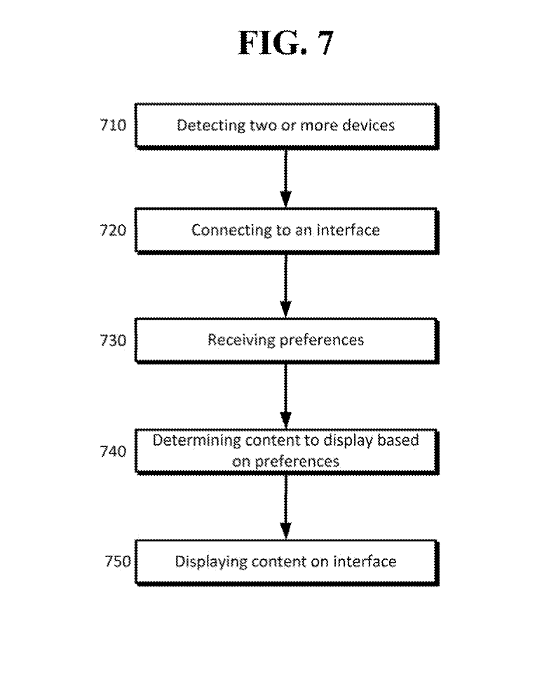

In an implementation, an example of which is provided in FIG. 7, two or more mobile devices may be detected at 710. Each of the two or more mobile devices may be connected to a publicly accessible interface at 720. The mobile devices may be connected by an application executed on the mobile device, by scanning a QR code to discover the interface, or by going to a URL via a web browser. For example, the URL may ascertain the location of the interface nearest the user using the location of radio towers to which the mobile device is connected or by GPS coordinates provided by the mobile device and comparing them to a list of known locations of the interfaces. The publicly accessible interface may be, for example, a digital sign or a digital sign and a podium.

Two or more preferences may be received by, for example, the digital sign or a computing device connected thereto at 730. For example, the publicly accessible interface may be connected to the Internet and, based on a mobile device connected to it, may request a profile of the user account associated with the mobile device. A preference may be received from each user connected to the interface at 740. For example, each user may have an account that the interface may be allowed to access or each mobile device may provide a preference as previously described. A personalized display may be provided on the publicly accessible interface based on the preference for each user at 750. For example, if three users are connected to the interface, then each user's preference may be utilized to generate a customized display of content to each user. As described earlier, the interface may display overlapping content to each of the users and, in some configurations, provide a recommendation to one or more of the users connected to the interface. Content may be selected by the one or more users and the one or more selections may be associated with the account of the user who made the selection.

According to an implementation, a system is provided that includes a database and a processor. The database may store at least one preference of at least one user. The processor may be connected to the database and configured to detect a first mobile device. It may receive a first preference corresponding to a first user. The processor may determine content to display to the first user on a digital sign, such as based on a first preference corresponding to the first user. Further, the processor may detect a second mobile device, receive a second preference corresponding to a second user, and determine content to display to the second user on the digital sign based on the second preference. The processor may be configured to provide a recommendation of at least one application to the first user, the second user, or to both users, such as by displaying suggested applications on the digital sign. In some configurations, the processor may detect a second mobile device and receive a second preference corresponding to a second user. It may determine content to display to the second user on the digital sign based on the first preference and the second preference and display the content to the second user on the digital sign.

In an implementation, a system is provided that includes a database and a processor. The database may store at least one preference from at least one user. The processor may be connected to the database and configured to detect a plurality of mobile devices, where each of the plurality of mobile devices is connected to a publicly accessible interface. It may receive a plurality of preferences, where one of the plurality of preferences is associated with one of the plurality of users. The processor may provide a personalized display on the publicly accessible interface based on the preference.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
detecting a first mobile device;
receiving a first preference corresponding to a first user;
determining content to display to the first user on a digital sign based on the first preference; and
displaying the content to the first user on the digital sign.

2. The method of claim 1, further comprising:
detecting a second mobile device;
receiving a second preference corresponding to a second user;
determining content to display to the second user on the digital sign based on the second preference; and
displaying the content to the second user on the digital sign.

3. The method of claim 2, further comprising:
providing a recommendation of at least one application to the first user, the second user, or the first user and the second user; and
displaying the recommendation to the first user, the second user, or the first user and second user on the digital sign.

4. The method of claim 1, further comprising receiving a selection of the content.

5. The method of claim 4, wherein the selection causes the content to be associated with an account of the first user.

6. The method of claim 1, further comprising:
detecting a second mobile device;
receiving a second preference corresponding to a second user;
determining content to display to the second user on the digital sign based on the first preference and the second preference; and
displaying the content to the second user on the digital sign.

7. The method of claim 6, further comprising:
determining content to display to the first user on the digital sign based on the second preference.

8. The method of claim 1, wherein supplemental content is displayed on the digital sign in addition the content displayed based on the first preference.

9. The method of claim 1, wherein content is selected from the group consisting of: a video, a digital copy of a book, an application, a digital copy of a magazine, and a digital copy of music.

10. The method of claim 1, wherein the digital sign comprises a plurality of monitors.

11. The method of claim 3, wherein the digital sign comprises a plurality of monitors.

12. The method of claim 11, further comprising assigning each user connected to the digital sign one of the plurality of monitors.

13. The method of claim 1, wherein a first preference is selected from the group consisting of: a gender, an age, a collection of applications on the mobile device, a subset of applications, a most-viewed application set, a most-used application set, a most recently used application set, a collection of movies, a collection of music, a most-listened to collection of music, a most-viewed to collection of movies, a collection of books, and a collection of magazines.

14. The method of claim 1, wherein a digital sign comprises a display that is accessible simultaneously by multiple users.

15. The method of claim 1, wherein a digital sign comprises a non-interactive screen.

16. A method comprising:
detecting a plurality of mobile devices, where each of the plurality of mobile devices is connected to a publicly accessible interface;
receiving a plurality of preferences, where one of the plurality of preferences is associated with one of the plurality of users; and
providing a personalized display on the publicly accessible interface based on the preference.

17. The method of claim 16, wherein the publicly accessible interface comprises a digital sign or a digital sign and a podium.

18. The method of claim 16, wherein the personalized display comprises a plurality of content items.

19. The method of claim 18, further comprising receiving a selection of at least one of the plurality of content items by one of the plurality of users.

20. The method of claim 18, wherein a content item is selected from the group consisting of: a video, a digital copy of a book, an application, a digital copy of a magazine, and a digital copy of music

21. The method of claim 19, wherein the selection causes the content item to be associated with an account of the one of the plurality of users.

22. The method of claim 16, wherein one of the plurality of preferences is selected from the group consisting of: a gender, an age, a collection of applications on the mobile device, a subset of applications, a most-viewed application set, a most-used application set, a most recently used application set, a collection of movies, a collection of music, a most-listened to collection of music, a most-viewed to collection of movies, a collection of books, and a collection of magazines.

23. The method of claim 16, wherein the publicly accessible interface comprises a display that is accessible simultaneously by the plurality of users or is a non-interactive screen.

24. A system comprising:
a processor connected to a database, the processor configured to:
detect a first mobile device;
receive a first preference corresponding to a first user;
store the first preference in the database;
determine content to display to the first user on a digital sign based on the first preference; and
display the content to the first user on the digital sign.

25. The system of claim 24, the processor further configured to:
detect a second mobile device;
receive a second preference corresponding to a second user;
determine content to display to the second user on the digital sign based on the second preference; and
display the content to the second user on the digital sign.

26. The system of claim 25, the process further configured to:
display a recommendation of at least one application to the first user, the second user, or the first user and second user on the digital sign.

27. The system of claim 24, the processor further configured to:
detect a second mobile device;
receive a second preference corresponding to a second user;
determine content to display to the second user on the digital sign based on the first preference and the second preference; and
display the content to the second user on the digital sign.

28. The system of claim 27, the processor further configured to:
determine content to display to the first user on the digital sign based on the second preference.

29. The system of claim 24, wherein the digital sign comprises a plurality of monitors.

30. A system comprising:
a database, wherein the database stores at least one preference from at least one user;
a processor connected to the database, the processor configured to:
detect a plurality of mobile devices, where each of the plurality of mobile devices is connected to a publicly accessible interface;
receive a plurality of preferences, where one of the plurality of preferences is associated with one of the plurality of users; and
provide a personalized display on the publicly accessible interface based on the preference.
